(19) United States
(12) Patent Application Publication
(10) Pub. No.: US 2008/0212461 A1
(43) Pub. Date: Sep. 4, 2008

(54) TRANSFORM-BASED SYSTEMS AND METHODS FOR RECONSTRUCTING STEERING MATRICES IN A MIMO-OFDM SYSTEM

(75) Inventors: Tarkesh Pande, Dallas, TX (US); Srinath Hosur, Plano, TX (US); Anuj Batra, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/040,750

(22) Filed: Feb. 29, 2008

Related U.S. Application Data
(60) Provisional application No. 60/892,470, filed on Mar. 1, 2007.

(51) Int. Cl. H04J 11/00

(52) U.S. Cl. 370/203

(57) ABSTRACT

Embodiments provide a transform-based method for representing steering matrices in transmit beamforming for a multiple-input multiple-output orthogonal frequency division multiplexing (MIMO-OFDM) system. Beamforming embodiments generate a transform-based representation of steering matrices for at least a subset of sub-carriers for which channel information is known. In some embodiments, a beamformer is able to receive transform matrices information for at least a subset of channel sub-carriers, and generate corresponding channel sub-carrier steering matrices. Some embodiments of a beamformee are able to map at least a subset of channel sub-carrier steering matrices to corresponding transform matrices information prior to transmitting the transform matrix information to a beamformer. Other embodiments of a beamformer are able to receive channel information for at least a subset of sub-carriers of a channel, and compute a transform-based representation of a steering matrix for each sub-carrier for which channel information is known.

### CROSS-REFERENCE TO RELATED APPLICATIONS

The present application claims priority to U.S. provisional patent application Ser. No. 60/892,470, filed Mar. 1, 2007 and entitled “Transform Based Method and Apparatus for Reconstructing Steering Matrices in a MIMO-OFDM System”, hereby incorporated herein by reference.

### BACKGROUND

As consumer demand for high data rate applications, such as streaming video, expands, technology providers are forced to adopt new technologies to provide the necessary bandwidth. Multiple Input Multiple Output (“MIMO”) is an advanced radio system that employs multiple transmit antennas and multiple receive antennas to simultaneously transmit multiple parallel data streams. Relative to previous wireless technologies, MIMO enables substantial gains in both system capacity and transmission reliability without requiring an increase in frequency resources.

MIMO systems exploit differences in the paths between transmit and receive antennas to increase data throughput and diversity. As the number of transmit and receive antennas is increased, the capacity of a MIMO channel increases linearly, and the probability of all sub-channels between the transmitter and receiver simultaneously fading decreases exponentially. As might be expected, however, there is a price associated with realization of these benefits. Recovery of transmitted information in a MIMO system becomes increasingly complex with the addition of transmit antennas. This becomes particularly true in MIMO orthogonal frequency-division multiplexing (OFDM) systems. Such systems employ a digital multi-carrier modulation scheme using numerous orthogonal sub-carriers.

Improvements are desired to achieve a favorable performance-complexity trade-off compared to existing MIMO detectors.

### BRIEF DESCRIPTION OF THE DRAWINGS

For a detailed description of exemplary embodiments of the invention, reference will be made to the accompanying drawings in which:

FIG. 1 illustrates an example multiple-input multiple-output orthogonal frequency-divisional multiplexing (MIMO-OFDM) system in which embodiments may be used to advantage;

FIG. 2 illustrates a flowchart of an interpolation method, according to embodiments; and

FIG. 3 illustrates an illustration of an interpolation process, according to embodiments.

### NOTATION AND NOMENCLATURE

Certain terms are used throughout the following description and claims to refer to particular system components. As one skilled in the art will appreciate, computer companies may refer to a component by different names. This document doe not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

It should be understood at the outset that although exemplary implementations of embodiments of the disclosure are illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

In light of the foregoing background, embodiments enable improved multiple-input multiple-output (MIMO) detection by providing transform-based systems and methods for representing steering matrices in transmit beamforming for a multiple-input multiple-output orthogonal frequency division multiplexing (MIMO-OFDM) system. Moreover, once steering matrices are so represented, embodiments may also be used for steering matrix interpolation, for example resulting from reduced or limited feedback from a beamformee. Advantages of embodiments include providing a faithful representation of the steering matrices, enabling steering matrices to be represented by a small set of parameters, enabling improved interpolation on steering matrices by using polynomial interpolation and spline interpolation, as examples.

Further, although embodiments will be described for the sake of simplicity with respect to wireless communication systems, it should be appreciated that embodiments are not so limited, and can be employed in a variety of communication systems.

To better understand embodiments of this disclosure, it should be appreciated that in a MIMO system, the received signal can be modeled as

r=Ha+n,

where H is the Nᵣₓ×Nₜₓ channel matrix, a is the transmitted data vector, n is the additive noise, while in a MIMO-OFDM system, the received signal for every sub-carrier can be modeled by

rᵢ=Hᵢaᵢ+nᵢ i=1 . . . N_{sub}

where Hᵢ is the Nᵣₓ×Nₜₓ channel matrix for the i^{th} sub-carrier, aᵢ is the transmitted data vector, nᵢ is additive white Gaussian noise and N_{sub} denotes the number of sub-carriers.

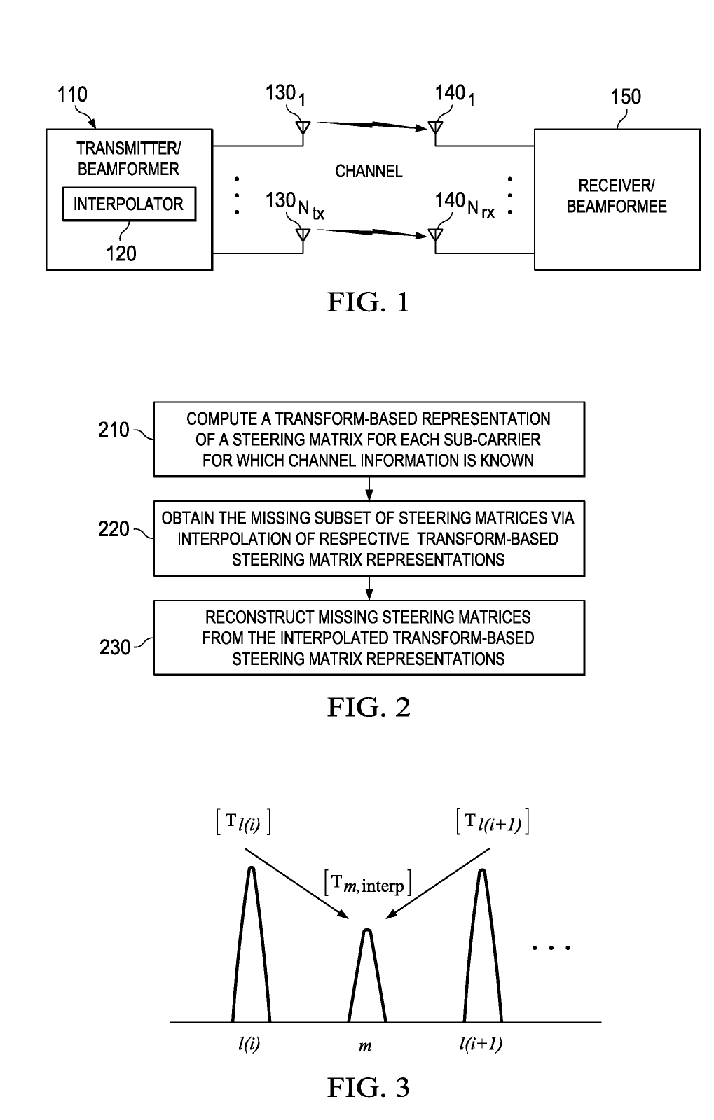

FIG. 1 depicts a MIMO-OFDM system which has the capability of adapting the signal to be transmitted to the channel by beamforming, in which embodiments may be used to advantage. As this system is a MIMO system, there are multiple transmitting antennas 130₁, . . . , 130_{N}_{ₜₓ}, where Nₜₓ is the number of transmitting antennas, and there are multiple receiving antennas 140₁, . . . , 140_{N}_{ᵣₓ}, where Nᵣₓ is the number of receiving antennas.

Channel knowledge at beamformer 110 is typically derived based on information received from receiver or beamformee 150. Embodiments of transmitter/beamformer 110 either computes or receives from beamformee 150 the steering matrices for all of the sub-carriers of the channel shared by beamformer 110 and receiver/beamformee 150. If transmitter or beamformer 110 has channel knowledge, it may transmit on the dominant modes of the channel for each sub-carrier in order to improve error performance; see for example, A. Scaglione, P. Stoica, S. Barbarossa, G. B. Giannakis and H. Sampath, “Optimal designs for space-time linear precoders and decoders,” IEEE Transactions on Signal Processing, Vol., 50, pp. 1051-1064, May 2002. This communications methodology, otherwise known as beamforming, involves pre-multiplying the data vector aᵢ with a steering matrix Q_{S}. The steering matrix is constrained to be a (nearly) orthonormal Nₜₓ×Nₛₜₛ complex matrix and generally corresponds to the right singular vectors of the channel matrix Hᵢ. The steering matrix can be determined from the singular value decomposition (SVD):

Hᵢ=UᵢΣᵢVᵢ^{H}; Q_{s,i}=V_{i;1:N}_{ₛₜₛ} i=1 . . . N_{ST}

where V_{i;1:N}ₛₜₛ denotes the first Nₛₜₛ columns of the Nₜₓ×Nₜₓ matrix Vᵢ, and Q_{s,i} is the corresponding steering matrix.

In practice, there are different ways a beamformer acquires information about the steering matrices for at least one of the subcarriers in any of the following ways or a combination thereof:
1. Implicit Beamforming—Beamformer 110 forms the channel estimates for the forward link based on a signal transmission from beamformee 150. Channel reciprocity is assumed between transmitter 110 and receiver 150. Beamformer 110 may perform a separate SVD on the transposed channel matrices for each of the sub-carriers, or just a subset of the sub-carriers to obtain the corresponding steering matrices.
2. Explicit Beamforming—Beamformee 150 measures the channel, and sends quantized steering matrix information to beamformer 110. There are three types of steering matrix feedback a beamformee can send with respect to explicit beamforming:
   a) Uncompressed steering matrix feedback: Each entry of the steering matrix is quantized and fed back to beamformer 110, resulting in a significant amount of feedback. For an Nₜₓ×Nₛₜₛ steering matrix, this corresponds to a total of 2NₜₓNₛₜₛ real parameters (real and imaginary) being quantized and fed back to beamformer 110.
   b) Compressed steering matrix feedback: Compression is accomplished by taking advantage of the fact that fewer than 2NₜₓNₛₜₛ real and independent parameters can be used to represent an orthonormal steering matrix. One parameterization which can be used to do this is the Givens rotations approach. Here, a steering matrix is represented by pairs of angles. This method is currently used in the IEEE 802.11n standard [IEEE P802.11n Draft Amendment to Standard for Information Technology-Telecommunications and information exchange between systems-Local and Metropolitan networks-Specific requirements-Part 6 11: Wireless LAN Medium Access Control (MAC) and Physical Layer (PHY) specifications: Enhancements for Higher Throughput, prepared by the 802.11 Working Group of the 802 Committee].
   c) Codebook-based steering matrix feedback: A third option is where a finite set of steering matrices called a codebook is known to both beamformer 110 and beamformee 150. For example, beamformee 150 chooses the index corresponding to the optimal steering matrix based on channel knowledge and conveys this information back to beamformer 110. However, two key issues in this type of feedback are the design of optimally sized codebooks and the decision criteria used for selecting the steering matrix, see for example the discussions of B. M. Hochwald, T. L. Marzetta, T. J. Richardson, W. Sweldens, and R. Urbanke, “Systematic design of unitary space-time constellations,” IEEE Trans. Info. Theory, vol. 46, no. 6, pp. 1962-1973, September 2000; T. Strohmer and R. W. Heath Jr., “Grassmannian frames with applications to coding and communications,” Appl. Comput. Harmonic Anal., vol. 14, pp. 257-275, May 2003; G. Han and J. Rosenthal, “Geometrical and Numerical Design of Structured Unitary Space Time Constellations,” IEEE Trans. on Info. Theory, Volume 52, Issue 8, August 2006, pages: 3722-3735; D. J. Love and R. W. Heath Jr., “Limited Feedback Unitary Precoding for Spatial Multiplexing Systems,” IEEE Trans. Info Theory, vol. 51, pp. 2967-2976, August 2005; and D. J. Love and R. W. Heath Jr., “Limited Feedback Unitary Precoding for Orthogonal Space-Time Block Codes,” IEEE Trans. on Sig. Proc., vol. 53, pp. 64-73, January 2005. This type of feedback scheme is also used in the IEEE 802.16 standard [IEEE 802.16 Air Interface for Fixed Broadband Wireless Access Systems].
3. Full-CSI Feedback Beamforming—Beamformee 150 measures the channel and sends back to beamformer 110 quantized channel gains for each transmit/receive antenna link. Beamformer 110 then performs an SVD on the quantized channel matrices to get the corresponding steering matrices. Again, the beamformer may only need to perform an SVD for a subset of subcarriers.

Ideally, the steering matrices are computed and known by a beamformer for all of the sub-carriers; however, performance constraints normally dictate that fewer than all steering matrices for all of the sub-carriers are provided to a beamformer. An example of a performance constraint is the limited number of feedback bits that can be transmitted to the beamformer in order to minimize overhead. In order to further reduce the feedback requirement, beamformee 150 may only send back the compressed/uncompressed steering matrix information for a subset of subcarriers. Thus, regardless of the beamforming method employed, it frequently happens that beamformer 110 only has steering matrix information for a subset of the sub-carriers of size N<N_{sub}. Let L(N)=<l(1), . . . , l(N)> denote the ordered set of indices indicating the sub-carrier locations whose steering matrix information is fed back. In general, there is no restriction on the inter-sub-carrier spacing i.e., it may be non-uniform (l(i+1)−l(i)≠l(i+2)−l(i+1)). However, existing systems, for example and not by way of limitation, such as 802.11n, only enable feedback to beamformer 110 of information concerning either every second or every fourth sub-carrier. Thus, while beamformer 110 can determine the steering matrices of such subsets of sub-carriers, the steering matrices of the remaining sub-carriers remains unknown. In other words, regardless of the beamforming method employed, if the steering matrix information made available to beamformer 110 is only for a subset of sub-carriers of size N<N_{sub}, then beamformer 110 must somehow define the steering matrices to be used for the remaining sub-carriers, i.e., the remaining sub-carriers that are shared between transmitting antennas 130 and receiving antennas 140 which are not in this subset.

In view of this, embodiments parameterize steering matrices using transform-based techniques. As an example, it is known that the Cayley transform of a skew-Hermitian matrix results in a corresponding unitary matrix; see for example, B. Hassibi and B. M. Hochwald, “Cayley Differential Unitary Space-Time Codes,” IEEE Trans. Info. Theory Vol. 48 pp 1485-1503, June 2002; and Y Jing and B. Hassibi, “Unitary-Space-Time Modulation,” IEEE Trans. on Sig. Proc., vol. 51, no. 11, November 2003, pages 2891-2904, which discuss transform-based techniques to devise efficient data encoding and data decoding techniques for differential unitary space-time modulation. Embodiments take advantage of this attribute, applying such a transform to parameterize steering matrices. Thus, mapping steering matrices to skew-Hermitian matrices is advantages as only half of the entries of the skew-Hermitian matrix are necessary to characterize the corresponding steering matrix. As a result: such transform enables embodiments of beamformee 150 to only need to quantize and feedback half the entries of the skew-Hermitian matrix for a given steering matrix, i.e., for the Nₜₓ×Nₜₓ steering matrix case, only Nₜₓ² parameters need to be quantized and fed back to beamformer 110, resulting in a two-fold improvement over the uncompressed feedback case. Simply, embodiments take advantage of transform-based techniques for representing steering matrices with fewer parameters

To accomplish this, embodiments use a transform-based technique to represent steering matrices. Three example transform embodiments which may be used to represent a steering matrix, and not by way of limitation, are: 1) embodiments which employ a Cayley transform 2) embodiments which employ an exponential-type transform that considers the steering matrix as a point on the Stiefel manifold, and 3) embodiments which employ a transform that considers the steering matrix as a point on the Grassmann manifold.

One way of describing the set of steering matrices is to consider them as points on higher dimensional surfaces such as Stiefel and Grassmann manifolds. Embodiments employing a Stiefel manifold-view in their representations of steering matrices will be discussed first.

A Stiefel manifold V(Nₜₓ, Nₛₜₛ) is defined as the subset of all Nₜₓ×Nₛₜₛ complex matrices satisfying the unitary constraint

V(Nₜₓ, Nₛₜₛ)={Qₛ ε C^{N}^{ₜₓ}^{×N}^{ₛₜₛ}: Qₛ^{H}×Qₛ=I_{N}_{ₛₜₛ}},

where I_{N}_{^{sts}} denotes the Nₛₜₛ×Nₛₜₛ identity matrix. When Nₜₓ=Nₛₜₛ, the Stiefel manifold corresponds to the unitary group U(Nₜₓ) or the set of Nₜₓ×Nₜₓ unitary matrices. For the case where Nₜₓ>Nₛₜₛ, the Stiefel manifold can be described as a quotient space written as V(Nₜₓ, Nₛₜₛ)=U(Nₜₓ)/U(Nₜₓ−Nₛₜₛ). From this description, it can be seen that two distinct matrices from U(Nₜₓ) map to the same matrix in V(Nₜₓ, Nₛₜₛ) if their first Nₛₜₛ columns are identical. An important relationship of the unitary group U(Nₜₓ) is with respect to its Lie algebra. The Lie algebra of a Lie group is defined as the tangent space at the identity element of the Lie group. Let Φ(t) be any path of unitary matrices that pass through the identity element i.e.,

Φ^{H}(t)×Φ(t)=I_{N}_{ₜₓ}, Φ(0)=I_{N}_{ₜₓ}, ∀tεR,

Taking the derivative at t=0 gives the relation

$${( \frac{\partial {Φ}^{H} ( t )}{\partial t} )}_{t = 0} + {( \frac{\partial Φ ( t )}{\partial t} )}_{t = 0} = 0.$$

Thus, the Lie algebra of the unitary group consists of Nₜₓ×Nₜₓ skew-Hermitian matrices. In this case, the map from the tangent space of skew-Hermitian matrices to the unitary group corresponds to the matrix exponential. Therefore, any unitary matrix can be specified in terms of a skew-Hermitian matrix by the relation

Qₛ=exp(iA) {Qₛ ε C^{N}^{ₜₓ}^{×N}^{ₜₓ}:Qₛ×Qₛ=I_{N}^{ₜₓ}}, {A ε C^{N}^{ₜₓ}^{×N}^{ₜₓ}:A=A^{H}}.

Note, that for a given steering matrix, one can obtain its corresponding skew-Hermitian matrix by the principle matrix logarithm

iA=Log(Qₛ) {Qₛ ε C^{N}^{ₜₓ}^{×N}^{ₜₓ}:Qₛ^{H}×Qₛ=I_{N}_{ₜₓ}}, {A ε C^{N}^{ₜₓ}^{×N}ₜₓ:A=A^{H}}

However, the matrix exponential is not the only map from the space of skew-Hermitian matrices to the unitary group. Let A be any Hermitian matrix. The Cayley transform of the skew-Hermitian matrix iA defined as

Qₛ=(I_{N}_{ₜₓ}+iA)⁻¹. (I_{N}_{ₜₓ}−iA),

results in a matrix Qₛ belonging to the unitary group. Since iA is skew-Hermitian, it does not have eigenvalues at −1 and therefore the above transformation is well-defined. It is also easy to show that the Cayley transform is one-to-one since

iA=(I_{N}_{ₜₓ}−Qₛ)·(I_{N}_{ₜₓ}+Qₛ)⁻¹.

Note that the set of steering matrices with eigenvalues at −1 is excluded since the inverse (I_{N}_{ₜₓ}+Qₛ)⁻¹ in the above equation is not well-defined. Solutions for using a Cayley transform when a steering matrix has an eigenvalue at −1 will be discussed later.

Finally, the extension from the space of Nₜₓ×Nₜₓ unitary matrices to the Stiefel manifold V(Nₜₓ, Nₛₜₛ) is a simple matter because this corresponds to a selection of the first Nₛₜₛ columns of the square unitary matrices i.e.,

$${Q}_{s} = exp ( i A ) \cdot [ \begin{matrix}{I}_{{N}_{sts}} \\ 0\end{matrix} ]$$

$$or$$

$${Q}_{s} = {( {I}_{{N}_{tx}} + i A )}^{- 1} \cdot ( {I}_{{N}_{tx}} - i A ) \cdot [ \begin{matrix}{I}_{{N}_{sts}} \\ 0\end{matrix} ] .$$

As noted earlier, mapping steering matrices to skew-Hermitian matrices is advantageous because only half of the entries of a skew-Hermitian matrix are necessary for beamformee 150 to send to beamformer 110 to enable beamformer 110 to characterize the corresponding steering matrix. Embodiments can therefore be used as a type of compressed matrix feedback. It should be appreciated that the space of skew-Hermitian matrices is also a natural choice of a space in which to do interpolation for steering matrices.

Other embodiments employ a Grassman manifold-view in their representations of steering matrices. To better understand these embodiments, it should be understood that in uncoded MIMO systems incorporating beamforming, system performance is dependent on the column space of the steering matrix; for more information on this, see for example, D. J. Love and R. W. Heath Jr., “Limited Feedback Unitary Precoding for Spatial Multiplexing Systems,” IEEE Trans. Info. Theory, vol. 51, pp. 2967-2976, August 2005; and D. J. Love and R. W. Heath Jr., “Limited Feedback Unitary Precoding for Orthogonal Space-Time Block Codes,” IEEE Trans. on Sig. Proc., vol. 53, pp. 64-73, January 2005. Thus, the performance of a beamforming system is unchanged if the steering matrix is post-multiplied by an Nₛₜₛ×Nₛₜₛ unitary matrix. Specifically, all steering matrices that span the same subspace can be considered to be equivalent from a system performance perspective. As a result, such steering matrices may be considered as points on the Grassmann manifold.

A Grassmann manifold G(Nₜₓ, Nₛₜₛ) is defined as the set of all Nₛₜₛ dimensional subspaces in an Nₜₓ dimensional space. Its quotient representation is written as G(Nₜₓ, Nₛₜₛ)=V(Nₜₓ, Nₛₜₛ)/U(Nₛₜₛ). From this description, it can be seen that two Nₜₓ×Nₛₜₛ matrices in the Stiefel manifold are equivalent if they span the same subspace i.e., one can be obtained from the other by right-multiplication with a matrix from U(Nₛₜₛ). Furthermore, a point on the Grassmann manifold can be shown to have the exponential parameterization:

$${Q}_{s} = exp ( \begin{matrix}0 & B \\ - {B}^{H} & 0\end{matrix} ) \cdot [ \begin{matrix}{I}_{{N}_{sts}} \\ 0\end{matrix} ] ,$$

where B ε C^{N}^{ₛₜₛ}^{×(N}^{ₜₓ}^{-N}^{ₛₜₛ}⁾. Note that the matrix B is characterized by only 2·Nₛₜₛ×(Nₜₓ−Nₛₜₛ) parameters and, therefore, is a complete description of the corresponding steering matrix. Thus, in an explicit feedback system one can use embodiments of beamformee 150 that quantize the matrix B for feedback to beamformer 110 as a type of compressed steering matrix feedback.

Embodiments of beamformee 150 or beamformer 110 can construct the matrix B, given a steering matrix, by performing a cosine-sine (CS) decomposition on the steering matrix using the generalized singular value decomposition (GSVD)

$${Q}_{s} = ( \begin{matrix}{U}_{1} & 0 \\ 0 & {U}_{2}\end{matrix} ) \cdot ( \begin{matrix}cos \sum \\ sin \sum \end{matrix} ) \cdot V ,$$

where U₁, V ε C^{N}^{ₜₓ}^{×N}^{ₛₜₛ}, U₂ ε C^{N}^{ₜₓ}^{-N}^{ₛₜₛ}^{×N}^{ₜₓ}−Nₛₜₛ. The diagonal elements of Σ correspond to the subspace angles between the identity element [I_{N}_{ₛₜₛ} 0]^{T} and the steering matrix Qₛ. The matrix B simplifies to B=U₂ ΣU₁.

For ease of understanding, the transform matrices obtained through parameterizing the Stiefel and Grassmann manifolds will hereafter be referred to as T=A and T=B, respectively.

Consider now, embodiments which use a Cayley transform for representing steering matrices. Earlier it was shown that the transform is undefined if the steering matrix had eigenvalues on −1. Indeed, even if the eigenvalues are in a close neighborhood of −1, the Cayley transform will result in some of the entries in the skew-Hermitian matrix being very large. This can potentially result in a large quantization error if only a finite number of bits are used for representing the entries of the skew-Hermitian matrix.

To address this problem, when system performance depends on the column space of the steering matrix, some embodiments post-multiply the steering matrix with an Nₛₜₛ×Nₛₜₛ unitary matrix F such that the preconditioned steering matrix QₛF does not have any eigenvalues in the neighborhood of −1. Some of such embodiments employ a codebook of matrices F={F₁, . . . , F_{N}} from which to test and choose. The codebook is preferably designed to reduce the complexity in matrix multiplication by constraining the columns of F to be columns from the identity matrix multiplied by ±1. The Cayley transform can then be carried out on the preconditioned matrix QₛF.

Other embodiments provide beamformer 110 or beamformee 150 with a codebook of steering matrices Q={Q_{s,1}, . . . , Q_{s,N}} from which to choose. The codebook is preferably designed such that the eigenvalues of the steering matrices are not within a predefined neighborhood or distance of −1. Some embodiments of the codebook will have a corresponding codebook T={T₁, . . . , T_{N}} of the equivalent transformation matrices. Such embodiments ensure that the transformation matrices exist and do not require any further computational cost once the desired steering matrix is determined. Thus, instead of computing the right singular vectors of the channel matrix, beamformee 150 or beamformer 110 may also directly choose the appropriate steering matrix from the codebook Q and the selected steering matrix's equivalent transformation matrix T from the codebook T based on a selection criterion. Examples of selection criteria for choosing a steering matrix include, but are not limited to:
maximizing the effective channel norm: arg min ∥HᵢQ_{s,i}∥_{F}²,
maximizing the minimum singular value: arg max λₘᵢₙ {HQ_{s,i}},
maximizing capacity:

$$arg max {log}_{2} det ( I + \frac{{E}_{s}}{{N}_{0}} {Q}_{s , i}^{H} {H}_{i}^{H} {H}_{i} {Q}_{s , i} ) ,$$

minimizing the mean square error:

$$arg min func . {( I + \frac{{E}_{s}}{{N}_{0}} {Q}_{s , i}^{H} {H}_{i}^{H} {H}_{i} {Q}_{s , i} )}^{- 1}$$

where func. refers to either the trace or determinant operation, λₘᵢₙ {•} refers to the minimum singular value, and ∥•∥_{F} refers to the Frobenius norm. It should be appreciated that in some embodiments, the steering matrices codebook alternatively has corresponding equivalent transformation matrices entries, instead of the transformation matrices codebook and the steering matrices codebook being independent codebooks.

If beamformee 150 or beamformer 110 already has prior knowledge of the optimal steering matrix Qₛ₋ₒₚₜ, it may instead determine the best entry (i.e., entry closest to the optimal steering matrix) in the codebook Q based on an objective function. As an appreciated, at this point, that no restriction has been placed on the spacing between subcarriers for which steering matrix information is known, i.e., it may be non-uniform, (l(i+1)−l(i)≠l(i+2)−l(i+1)). However, knowledge of the sub-carrier spacing is useful in the interpolation process. A discussion on how the set of sub-carriers L(N) is chosen for feedback is provided later.

Specifically, and as illustrated in FIG. 2, interpolator 120 of beamformer 110 obtains the missing subset of transform matrices via interpolation (function 220) for the m^{th} subcarrier by performing:

T_{m,int erp}=f(S(L(N)),m),

where f (•) is an appropriate interpolation function. Some examples of interpolation functions that might be used by embodiments include, but are not limited to, linear functions, polynomial functions, rational functions, or spline-based functions. As the interpolation is done on a vector space, the interpolation itself is relatively easy and, as is readily apparent after considering the teachings of the present disclosure, a great variety of interpolation functions may be used as desired; see for example, M. Schatzman, Numerical Analysis: A Mathematical Introduction, Clarendon Press, Oxford 2002.

It should be appreciated that, although interpolator 120 is illustrated as part of beamformer 110, that the location of interpolator 120 could be otherwise, e.g., separate from both beamformer 110 and beamformee 150, etc. It should be understood that operations carried out by interpolator 120 can alternatively be performed in software or by an application-specific integrated circuit (ASIC). Moreover, in some embodiments, the interpolation function might also be a linear filter. The filter span and the type would be changed based on the specific channel encountered. For example, if the channel encountered does not vary rapidly from sub-carrier to sub-carrier, a linear interpolation over neighboring pairs of transform matrices may be sufficient. Linear interpolation may be defined as

$${T}_{m , interp} = ( 1 - α ) {T}_{l ( i )} + α {T}_{l ( i + 1 )} ;$$

$$α = \frac{m - l ( i )}{l ( i + 1 ) - l ( i )} ;$$

$$l ( i ) < m < l ( i + 1 ) .$$

example, and not by way of limitation, if the system performance is dependent on the column space of the steering matrix and the codebook is designed on the Grassmann manifold, an appropriate choice of an objective function is to minimize the distance metric between the optimal steering matrix and the codebook entries. Some examples of distance metrics include, but are not limited to:

Chordal distance=2^{-1/2}∥Qₛ₋ₒₚₜ^{H}Qₛ₋ₒₚₜ−Q_{s,i}^{H}Q_{s,i}∥_{F},

Fubini-Study Distance=arc cos |det Qₛ₋ₒₚₜQ_{s,i}^{H}|,

Projection 2-norm Distance=∥Qₛ₋ₒₚₜ^{H}Qₛ₋ₒₚₜ−Q_{s,i}^{H}Q_{s,i}∥₂,

Of course, for codebooks designed on the Stiefel manifold, some examples of objective functions include, but are not limited to:

arg max Trace(Qₛ₋ₒₚₜQₛ₋ₒₚₜ^{H}Q_{s,i}Q_{s,i}^{H}),

arg min ∥Qₛ₋ₒₚₜ−Q_{s,i}∥_{F}

where arg max is the argument of the maximum, and arg min is the argument of the minimum.

If steering matrix information for only a subset of subcarriers of size N<N_{ST} is available to beamformer 110, it somehow needs to define the steering matrices to be used for the subcarriers that are not in this subset. Embodiments address this problem by obtaining the missing transform matrices via interpolation and then using the interpolated matrices to reconstruct the missing steering matrices. Let

S(L(N))=<Tₗ₍₁₎, Tₗ₍₂₎, . . . , T_{l(N)}>l(i)<l(i+1)

denote the set of parameterizing transform matrices for a subset of N subcarriers. Quantized S(L(N)) is precisely the channel information that the beamformee sends back to the beamformer in the compressed steering matrix feedback scenario. It should be FIG. 3 gives a pictorial representation of such an embodiment. If, however, the channel has a high degree of frequency selectivity, an interpolation function such as a higher-order polynomial function, rational function or spline-based function may be more effective. In some embodiments, the system might employ a channel classifier, see for example and not limitation, that described in “Systems and Methods for Efficient Channel Classification”, U.S. patent application Ser. No. 12/024,029, hereby incorporated fully herein by reference, to guide the selection of an appropriate interpolation function based on the channel type and sub-carrier spacing. Beamformer 110 then reconstructs the steering matrices from the interpolated transform matrices based on the embodiments described above (function 230).

Selection of the sub-carriers for which steering matrix information is to be fed back to beamformer 110 and the location of the selected sub-carriers is typically made by beamformee 150. One approach to achieve improved efficiency is for beamformee 150 to choose the fewest number of sub-carriers, and their locations, such that the error (quantified by a cost function C(L(N)) between the interpolated transform matrices and the actual transform matrices for all sub-carriers is less than a predefined threshold. Typical cost functions involve computing different norms of the error vector between the true value T_{m,true} and the interpolated estimate T_{m,interp}. In such embodiments, the decision rule for determining a minimum number of sub-carriers N* and their locations L(N*) can be computed as follows:

| | |
|---|---|
| For | N = 2, . . . , N_{ST} |
| | For each L(N) |
| | $C ( L ( N ) ) = {\sum }_{{i = 1}_{i ∉ L ( N )}}^{{N}_{ST}} ‖ {T}_{i , true} - {f ( S ( L ( N ) ) , i ‖}_{F}$ |

| | |
|---|---|
| if | C(L(N)) < threshold |
| | N* = N |
| | L(N* ) = L(N) |
| | return |

end

end
end

The spacing information selected by beamformee 150 can be sent by the beamformee along with the other channel information. In some embodiments, the beamformer/beamformee classifies the channel type using an appropriate classifier; see for example and not by way of limitation, “Systems and Methods for Efficient Channel Classification”, Ser. No. 12/024,029 for “Systems and Methods for Efficient Channel Classification” incorporated herein by reference concurrently filed herewith and incorporated fully herein by reference. Regardless of how the channel type is ascertained, an appropriate L(N) is selected from a predefined look-up table based on the channel type. In such embodiments, beamformee 150 preferably only sends the index from the predefined look-up table to beamformer 110. Beamformer 110 then uses the index to look-up the corresponding sub-carrier spacing information to use to compute a transform-based representation of a steering matrix for each sub-carrier for which channel information is known, interpolate the respective transform-based steering matrix representations, and reconstructs the missing steering matrices from the interpolated transform-based steering matrix representations.

Many modifications and other embodiments of the invention will come to mind to one skilled in the art to which this invention pertains having the benefit of the teachings presented in the foregoing descriptions, and the associated drawings. Therefore, the above discussion is meant to be illustrative of the principles and various embodiments of the disclosure; it is to be understood that the invention is not to be limited to the specific embodiments disclosed. Although specific terms are employed herein, they are used in a generic and descriptive sense only and not for purposes of limitation. It is intended that the following claims be interpreted to embrace all such variations and modifications.

What is claimed is:

1. A multiple-input multiple-output orthogonal frequency division multiplexing (MIMO-OFDM) system, comprising:
a beamformer for receiving channel information for at least a subset of sub-carriers of a channel, and computing a transform-based representation of a steering matrix for each sub-carrier for which channel information is known.

2. The system of claim 1, wherein the beamformer further interpolates the transform-based representation of the steering matrix for each sub-carrier of the subset to obtain the transform-based representation of the steering matrix for remaining sub-carriers which are not members of the subset.

3. The system of claim 2, wherein the beamformer further reconstructs missing steering matrices from the interpolated transform-based representation of the steering matrix for the remaining sub-carriers which are not members of the subset.

4. The system of claim 1, wherein the beamformer employs a codebook of transform matrices in computing the transform-based representation of the steering matrix, and minimizes a distance metric between an optimal steering matrix and a codebook entry selected.

5. The system of claim 4, wherein transform matrices in the codebook are specified such that eigenvalues of corresponding steering matrices are not within a predefined distance of −1.

6. The system of claim 4, wherein the beamformer further employs a codebook of equivalent transformation matrices with one-to-one correspondence to respective steering matrices.

7. The system of claim 4, wherein the distance metric is selected from the group of: chordal distance, Fubini-Study distance, projection 2-norm distance, argument of maximum and argument of minimum.

8. A method for beamforming, comprising:
generating a transform-based representation of steering matrices for at least a subset of sub-carriers for which channel information is known.

9. The method of claim 8, further comprising transmitting the transform-based representation to a beamformer.

10. The method of claim 8, further comprising interpolating the transform-based representation to reconstruct transform-based representation of steering matrices for remaining sub-carriers which are not members of the subset.

11. The method of claim 10, further comprising constructing missing steering matrices from the interpolated transform-based representation of steering matrices for the remaining sub-carriers which are not members of the subset.

12. The method of claim 8, wherein the generating further comprises employing a codebook of transform matrices in computing the transform-based representation of steering matrices, and minimizing a distance metric between an optimal steering matrix and a codebook entry selected.

13. The method of claim 12, wherein the minimizing further comprises applying a distance metric selected from the group of: chordal distance, Fubini-Study distance, and projection 2-norm distance.

14. The method of claim 12, wherein the employing further comprises employing a codebook eigenvalues of steering matrices which are not within a predefined distance of −1.

15. A multiple-input multiple-output orthogonal frequency division multiplexing (MIMO-OFDM) system, comprising:
a beamformee that maps at least a subset of channel sub-carrier steering matrices to corresponding transform matrices information prior to transmitting the transform matrix information to a beamformer.

16. The system of claim 15, wherein the transmitted transform matrices information is quantized transform matrices.

17. The system of claim 16, wherein a beamformer constructs steering matrices from quantized transform matrices.

18. The system of claim 15, wherein the transmitted transform matrices information is codebook indices which specify corresponding transform matrices for given steering matrices.

19. The system of claim 18, wherein the indices are specified such that corresponding steering matrices do not have eigenvalues at −1.

20. The system of claim 18, wherein the codebook indices are selected to minimize a distance metric between an optimal steering matrix and a codebook entry selected.

21. The system of claim 20, wherein the distance metric to be minimized is selected from the group of: chordal distance, Fubini-Study distance, projection 2-norm distance, argument of maximum and argument of minimum.

22. The system of claim 15, wherein the beamformee, in mapping the steering matrices to corresponding transform matrices information, employs at least one transformation technique selected from the group of: cayley transform, an exponential map or a cosine-sine (CS)-based decomposition.

23. The system of claim 15, wherein the beamformee applies a post-conditioning matrix on the steering matrices so that the steering matrices do not have eigenvalues at −1.

24. A multiple-input multiple-output orthogonal frequency division multiplexing (MIMO-OFDM) system, comprising:
a beamformer for receiving transform matrices information for at least a subset of channel sub-carriers, and for generating corresponding channel sub-carrier steering matrices.

25. The system of claim 24, wherein the received transform matrices information is quantized transform matrices.

26. The system of claim 24, wherein the transform matrices information was generated by employing at least one transformation technique selected from the group of: cayley transform, an exponential map or a cosine-sine (CS)-based decomposition.

27. The system of claim 24, wherein the beamformer interpolates the transform matrices information to reconstruct transform matrices for remaining sub-carriers not of the subset of sub-carriers.

28. The system of claim 24, wherein the received transform matrices information is codebook indices which specify corresponding transform matrices for given steering matrices.

29. The system of claim 28, wherein the codebook indices are selected to minimize a distance metric between an optimal steering matrix and a codebook entry selected.

30. The system of claim 29, wherein the distance metric to be minimized is selected from the group of: chordal distance, Fubini-Study distance, and projection 2-norm distance.
